(19) United States
(12) Patent Application Publication
(10) Pub. No.: US 2025/0178968 A1
(43) Pub. Date: Jun. 5, 2025

(54) PROCESSES AND MATERIALS FOR CASTING AND SINTERING GREEN GARNET THIN FILMS

(71) Applicant: QuantumScape Battery, Inc., San Jose, CA (US)

(72) Inventors: Oleh KARPENKO, San Jose, CA (US); Gengfu Xu, San Jose, CA (US); Niall Donnelly, San Jose, CA (US); Sriram Iyer, San Jose, CA (US); Timothy Holme, San Jose, CA (US)

(21) Appl. No.: 19/022,525

(22) Filed: Jan. 15, 2025

Related U.S. Application Data
(63) Continuation of application No. 18/643,795, filed on Apr. 23, 2024.
Application No. 18/643,795 is a continuation of application No. 17/588,108, filed on Jan. 28, 2022, now abandoned.
Application No. 17/588,108 is a continuation of application No. 16/734,196, filed on Jan. 3, 2020, now Pat. No. 12,084,387.
Application No. 16/734,196 is a continuation of application No. 15/216,636, filed on Jul. 21, 2016, now abandoned.
(60) Provisional application No. 62/195,172, filed on Jul. 21, 2015.

(51) Int. Cl. C04B 35/50; B32B 18/00; B32B 37/16; C04B 35/486; C04B 35/622; C04B 35/626; C04B 35/634; C04B 35/638; C04B 35/64; H01M 10/052; H01M 10/0525; H01M 10/0562

(52) U.S. Cl. CPC C04B 35/50; B32B 18/00; B32B 37/16; C04B 35/486; C04B 35/62218; C04B 35/6261; C04B 35/6264; C04B 35/634; C04B 35/6342; C04B 35/638; C04B 35/64; H01M 10/052; H01M 10/0525; H01M 10/0562; C04B 2235/3203; C04B 2235/3217; C04B 2235/3227; C04B 2235/3248; C04B 2235/5409; C04B 2235/5436; C04B 2235/5445; C04B 2235/5463; C04B 2235/6025; C04B 2235/608; C04B 2235/6584; C04B 2235/6588; C04B 2235/66; C04B 2235/764; C04B 2237/34; C04B 2237/343; C04B 2237/346; C04B 2237/562; H01M 2300/0068; H01M 2300/0071

(57) ABSTRACT

Set forth herein are processes and materials for making ceramic thin films by casting ceramic source powders and precursor reactants, binders, and functional additives into unsintered thin films and subsequently sintering the thin films under controlled atmospheres and on specific substrates.

This application claims priority to, and the benefit of, U.S. Provisional Patent Application No. 62/195,172, entitled PROCESSES AND MATERIALS FOR CASTING AND SINTERING GREEN GARNET THIN FILMS, which was filed Jul. 21, 2015, the contents of which are herein incorporated by reference in their entirety for all purposes.

### FIELD

The present disclosure concerns precursors to inorganic thin films (e.g., green tapes or sintered films made from green tapes), processes for using these precursors to make sintered thin films, and sintered thin films made by the processes set forth herein. In some examples, the sintered thin films made by the processes set forth herein are useful as solid electrolytes in rechargeable batteries. In many examples, the green tapes which are set forth herein and used to make sintered thin films have a higher solid loading than known green tapes. The sintered thin films prepared by the processes herein have a lower porosity, a higher density, less defects, and, or, are prepared in higher yield than known sintered thin films.

### BACKGROUND

Solid state ceramics, such as lithium-stuffed garnet materials and lithium borohydrides, oxides, sulfides, oxyhalides, and halides have several advantages as materials for ion-conducting electrolyte membranes and separators in a variety of electrochemical devices including fuel cells and rechargeable batteries. When compared to their liquid-based counterparts, the aforementioned solid ceramics possess safety and economic advantages as well as advantages related to the material's solid state and density which allows for correspondingly high volumetric and gravimetric energy densities when these materials are incorporated into electrochemical devices as electrolyte separators. Solid state ion conducting ceramics are well suited for solid state electrochemical devices because of their high ion conductivity properties in the solid state, their electric insulating properties, as well as their chemical compatibility with a variety of species such as lithium metal and their stability to a wide window of voltages.

Although solid state ion conducting ceramics have a series of advantageous and beneficial properties, these materials suffer from a range of issues related to forming green films (i.e., green tapes) and to subsequently sintering these green films. When solid state ion conducting ceramics are typically formulated as thin films and sintered, these films have a tendency to stick to the substrate on which they are prepared, to crack or warp on account of the processing conditions, or are too brittle post-sintering to handle and manipulate. In particular, during sintering of thin films, these films have a tendency to crack, warp, or otherwise have surface deteriorations.

There is therefore a series of problems in the relevant field related to casting green tapes of ceramics, such as but not limited to garnets and lithium sulfides, and to sintering these green tapes to prepare high density garnet thin films. What is needed in the relevant field is, for example, new materials and processes for casting green tapes and for sintering the same. The instant disclosure sets forth such materials and processes, in addition to making and using the same, and other solutions to problems in the relevant field.

### SUMMARY

In one embodiment, the instant disclosure sets forth methods for casting a thin film tape, in which the methods include, generally, providing at least one source power, modifying the at least one source powder to prepare a modified source powder, providing a slurry of the modified source powder, casting the slurry to form a green tape, drying the green tape; and sintering the green tape to form a sintered thin film.

In a second embodiment, the instant disclosure sets forth a slurry for casting a green tape, in which the slurry includes a source powder, optionally precursors to the source powder, and at least one member selected from binders, dispersants, and solvents.

In a third embodiment, the instant disclosure sets forth a method for sintering a green tape, the method including: (a) providing at least one source powder; (b) modifying the at least one source powder to prepare a modified source powder; (c) providing a slurry of the modified source powder; (d) casting the slurry to form a green tape; (e) drying the green tape; and (f) sintering the green tape; thereby sintering a green tape.

In a fourth embodiment, the instant disclosure sets forth a slurry for preparing a cast green film, the slurry including:
at least two or more of:
   a solvent selected from the group consisting of methanol, ethanol, MEK, isopropanol, acetone, cyclohexanone, toluene, acetic acid, and benzene;
   a binder selected from the group consisting of fish oil, PVB, KD1, an acrylic acid, triton, phosphate esters, and derivatives thereof;
   a plasticizer selected from the group consisting of a benzyl butyl phthalate or di-butyl phthalate;
   a pH modifier;
   a sintering aid selected from the group consisting; and
   a source powder selected from a lithium-stuffed garnet

In a fifth embodiment, the instant disclosure sets forth a green tape, including:
a source powder;
a solvent;
a binder; and
a dispersant;
wherein the green tape has a picnometry density greater than 3.9 and less than 5.0.

In a sixth embodiment, the instant disclosure sets forth a method of making a green tape, including the following steps: (a) providing a slurry; (b) providing a binder mixture; (c) mixing the slurry with the binder mixture to form a mixed slurry; and (d) casting the mixed slurry to provide a green tape, wherein the green tape has a total organic content of about 10-25% w/w.

### BRIEF DESCRIPTIONS OF THE DRAWINGS

FIG. 1 shows an example flow chart in accordance with an embodiment of the methods set forth herein.

FIG. 2 shows a scanning electron microscopy (SEM) image of a green tape made by the casting methods set forth in Example 1. The tape include 15% binder, the garnet had a d₅₀ of about 180 nm, and a density of 2.3 g/cm³. The organic portion is labeled 201, and the inorganic portion is labeled 202.

FIG. 3 shows an optical image of a 100-200 μm sintered green tape, prepared by Example 3.

FIG. 4 shows a scanning electron microscopy (SEM) image of a sintered tape made by Example 2 with slurry composition 1 and binder composition 1.

The figures depict various embodiments of the present disclosure for purposes of illustration only. One skilled in the art will readily recognize from the following discussion that alternative embodiments of the structures and methods illustrated herein may be employed without departing from the principles described herein.

The following description is presented to enable one of ordinary skill in the art to make and use the disclosed subject matter and to incorporate it in the context of particular applications. Various modifications, as well as a variety of uses in different applications will be readily apparent to those skilled in the art, and the general principles defined herein may be applied to a wide range of embodiments. Thus, the present disclosure is not intended to be limited to the embodiments presented, but is to be accorded the widest scope consistent with the principles and novel features disclosed herein.

In the following detailed description, numerous specific details are set forth in order to provide a more thorough understanding of the present disclosure. However, it will be apparent to one skilled in the art that the present disclosure may be practiced without necessarily being limited to these specific details. In other instances, well-known structures and devices are shown in block diagram form, rather than in detail, in order to avoid obscuring the present disclosure.

### DETAILED DESCRIPTION

The disclose herein sets forth green tapes, processes for making these tapes, and processes for sintering these tapes. The processes herein produce sintered thin films having improved surface qualities when compared with films prepared by conventionally known methods. Some of the films prepared by the methods described herein are prepared with uniformly rough (i.e., smooth) surfaces. These films have a surface, as sintered, which is suitable for incorporation into an electrochemical device without further processing, such as polishing or lapping. Depending on the particular application, it may be necessary to process the sintered films prepared herein by polishing or lapping, but for other applications the films, as sintered by the methods set forth herein, are suitable for electrochemical device applications. In some examples, the films prepared herein have a surface roughness less than 5 μm post-sintering.

### A. DEFINITIONS

As used herein, “providing” refers to the provision of, generation or, presentation of, or delivery of that which is provided. Providing includes making something available. For example, providing a power refers to the process of making the powder available, or delivering the powder, such that the powder can be used as set forth in a method described herein. As used herein, providing also means measuring, weighing, transferring combining, or formulating.

As used herein, “casting” means to provide, deposit, or deliver a cast solution or slurry onto a substrate. Casting includes, but is not limited to, slot casting, dip coating, and doctor blading. As used herein, the phrase “slot casting,” refers to a deposition process whereby a substrate is coated, or deposited, with a solution, liquid, slurry, or the like by flowing the solution, liquid, slurry, or the like, through a slot or mold of fixed dimensions that is placed adjacent to, in contact with, or onto the substrate onto which the deposition or coating occurs. In some examples, slot casting includes a slot opening of about 1 to 100 μm. As used herein, the phrase “dip casting” or “dip coating” refers to a deposition process whereby substrate is coated, or deposited, with a solution, liquid, slurry, or the like, by moving the substrate into and out of the solution, liquid, slurry, or the like, often in a vertical fashion. As used herein, “casting a slurry” refers to a process wherein a slurry is deposited onto, or adhered to, a substrate. Casting can include, but is not limited to, slot casting and dip casting. As used herein, the phrase “slot casting,” refers to a deposition process whereby a substrate is coated, or deposited, with a solution, liquid, slurry, or the like by flowing the solution, liquid, slurry, or the like, through a slot or mold of fixed dimensions that is placed adjacent to, in contact with, or onto the substrate onto which the deposition or coating occurs. In some examples, slot casting includes a slot opening of about 1 to 100 μm. As used herein, the phrase “dip casting” or “dip coating” refers to a deposition process whereby substrate is coated, or deposited, with a solution, liquid, slurry, or the like, by moving the substrate into and out of the solution, liquid, slurry, or the like, often in a vertical fashion. As used herein, casting also includes depositing, coating, or spreading a cast solution or cast slurry onto a substrate. As used herein the phrase “casting a film,” refers to the process of delivering or transferring a liquid or a slurry into a mold, or onto a substrate, such that the liquid or the slurry forms, or is formed into, a film. Casting may be done via doctor blade, meyer rod, comma coater, gravure coater, microgravure, reverse comma coater, slot dye, slip and/or tape casting, and other methods known to those skilled in the art.

As used herein the phrase “casting a film,” refers to the process of delivering or transferring a liquid or a slurry into a mold, or onto a substrate, such that the liquid or the slurry forms, or is formed into, a film. Casting may be done via doctor blade, Meyer rod, comma coater, gravure coater, microgravure, reverse comma coater, slot dye, slip and/or tape casting, and other methods known to those skilled in the art.

As used herein, the phrase “slot casting,” refers to a deposition process whereby a substrate is coated, or deposited, with a solution, liquid, slurry, or the like by flowing the solution, liquid, slurry, or the like, through a slot or mold of fixed dimensions that is placed adjacent to, in contact with, or onto the substrate onto which the deposition or coating occurs. In some examples, slot casting includes a slot opening of about 1 to 100 μm.

As used herein, the phrase “dip casting” or “dip coating” refers to a deposition process whereby substrate is coated, or deposited, with a solution, liquid, slurry, or the like, by moving the substrate into and out of the solution, liquid, slurry, or the like, often in a vertical fashion.

As used herein, the term “laminating” refers to the process of sequentially depositing a layer of one precursor specie, e.g., a lithium precursor specie, onto a deposition substrate and then subsequently depositing an additional layer onto an already deposited layer using a second precursor specie, e.g., a transition metal precursor specie. This laminating process can be repeated to build up several layers of deposited vapor phases. As used herein, the term “laminating” also refers to the process whereby a layer comprising an electrode, e.g., positive electrode or cathode active material comprising layer, is contacted to a layer comprising another material, e.g., garnet electrolyte. The laminating process may include a reaction or use of a binder which adheres or physically maintains the contact between the layers which are laminated. Laminating also refers to the process of bringing together unsintered, i.e. “green” ceramic films.

As used herein, the phrase “green tape” or “green film” refers to an unsintered film including at least one member selected from garnet materials, precursors to garnet materials, binder, solvent, carbon, dispersant, or combinations thereof.

As used herein, the phrase “film thickness” refers to the distance, or median measured distance, between the top and bottom faces of a film. As used herein, the top and bottom faces refer to the sides of the film having the largest surface area.

As used herein, the phrases “garnet precursor chemicals,” “chemical precursor to a Garnet-type electrolyte,” or “garnet chemical precursors” refers to chemicals which react to form a lithium stuffed garnet material described herein. These chemical precursors include, but are not limited to, lithium hydroxide (e.g., LiOH), lithium oxide (e.g., Li₂O), lithium carbonate (e.g., LiCO₃), zirconium oxide (e.g., ZrO₂), lanthanum oxide (e.g., La₂O₃), aluminum oxide (e.g., Al₂O₃), aluminum (e.g., Al), aluminum nitrate (e.g., AlNO₃), aluminum nitrate nonahydrate, aluminum (oxy) hydroxide (gibbsite and boehmite), gallium oxide, niobium oxide (e.g., Nb₂O₅), and tantalum oxide (e.g., Ta₂O₅).

As used herein, the phrase “subscripts and molar coefficients in the empirical formulas are based on the quantities of raw materials initially batched to make the described examples” means the subscripts, (e.g., 7, 3, 2, 12 in Li₇La₃Zr₂O₁₂ and the coefficient 0.35 in 0.35Al₂O₃) refer to the respective elemental ratios in the chemical precursors (e.g., LiOH, La₂O₃, ZrO₂, Al₂O₃) used to prepare a given material, (e.g., Li₇La₃Zr₂O₁₂·0.35Al₂O₃). As used here, the phrase “characterized by the formula,” refers to a molar ratio of constituent atoms either as batched during the process for making that characterized material or as empirically determined.

As used herein the term “solvent,” refers to a liquid that is suitable for dissolving or solvating a component or material described herein. For example, a solvent includes a liquid, e.g., toluene, which is suitable for dissolving a component, e.g., the binder, used in the garnet sintering process.

As used herein the phrase “removing a solvent,” refers to the process whereby a solvent is extracted or separated from the components or materials set forth herein. Removing a solvent includes, but is not limited to, evaporating a solvent. Removing a solvent includes, but is not limited to, using a vacuum or a reduced pressure to drive off a solvent from a mixture, e.g., an unsintered thin film. In some examples, a thin film that includes a binder and a solvent is heated or also optionally placed in a vacuum or reduced atmosphere environment in order to evaporate the solvent to leave the binder, which was solvated, in the thin film after the solvent is removed.

As used herein, “thin” means, when qualifying a film, membrane, or the like, a dimension less than 200 μm, more preferably less than 100 μm and in some cases between 0.1 and 60 μm.

As used herein, “film tape” refers to a roll or continuous layer of casted tape, either dry or not dry, which is sintered or can be sintered.

As used herein, a “binder” refers to a material that assists in the adhesion of another material. For example, as used herein, polyvinyl butyral is a binder because it is useful for adhering garnet materials. Other binders include polycarbonates. Other binders may include polymethylmethacrylates. These examples of binders are not limiting as to the entire scope of binders contemplated here but merely serve as examples. Binders useful in the present disclosure include, but are not limited to, polypropylene (PP), atactic polypropylene (aPP), isotactive polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), PE-co-poly(methylene cyclopentane) (PE-co-PMCP), poly methyl-methacrylate (and other acrylics), acrylic, polyvinylacetacetal resin, polyvinylbutylal resin, PVB, polyvinyl acetal resin, stereoblock polypropylenes, polypropylene polymethylpentene copolymer, polyethylene oxide (PEO), PEO block copolymers, silicone, and the like.

As used here, the phrase “lithium-stuffed garnet electrolyte,” refers to oxides that are characterized by a crystal structure related to a garnet crystal structure. Lithium-stuffed garnets include compounds having the formula Li_{A}La_{B}M′M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0<C<2, 0<D<2; 0≤E<2, 10<F<13, and M″ and M″ are each, independently in each instance selected from Al, Mo, W, Nb, Sb, Ca, Ba, Sr, Ce, Hf, Rb, or Ta, or LiₐLa_{b}Zr_{c}Al_{d}Me″ₑO_{f}, wherein 5<a<7.7; 2<b<4; 0<c≤2.5; 0≤d<2; 0≤e<2, 10<f<13 and Me″ is a metal selected from Nb, Ta, V, W, Mo, Ga, or Sb and as described herein. Garnets, as used herein, also include those garnets described above that are doped with Al₂O₃. Garnets, as used herein, also include those garnets described above that are doped so that Al³⁺ substitutes for Li⁺. As used herein, lithium-stuffed garnets, and garnets, generally, include, but are not limited to, Li_{7.0}La₃(Zrₜ₁+Nbₜ₂+Taₜ₃)O₁₂+0.35Al₂O₃; wherein (t1+t2+3=subscript 2) so that the La:(Zr/Nb/Ta) ratio is 3:2. Also, garnet used herein includes, but is not limited to, LiₓLa₃Zr₂O₁₂+yAl₂O₃, wherein x ranges from 5.5 to 9; and y ranges from 0 to 1. In some examples x is 6-7 and y is 1.0. In some examples x is 7 and y is 0.35. In some examples x is 6-7 and y is 0.7. In some examples x is 6-7 and y is 0.4. Also, garnets as used herein include, but are not limited to, LiₓLa₃Zr₂O₁₂+yAl₂O₃. Non-limiting example lithium-stuffed garnet electrolytes are found, for example, in US Patent Application Publication No. 2015-0200420 A1, which published Jul. 16, 2015.

As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein the phrase “garnet-type electrolyte,” refers to an electrolyte that includes a lithium stuffed garnet material described herein as the ionic conductor. The advantages of Li-stuffed, garnet solid state electrolytes are many, including as a substitution for liquid, flammable electrolytes commonly used in lithium rechargeable batteries.

As used herein, the phrase “d₅₀ diameter” refers to the median size, in a distribution of sizes, measured by microscopy techniques or other particle size analysis techniques, such as, but not limited to, scanning electron microscopy or dynamic light scattering. D₅₀ includes the characteristic dimension at which 50% of the particles are smaller than the recited size.

As used herein, the phrase “d₉₀ diameter” refers to the median size, in a distribution of sizes, measured by microscopy techniques or other particle size analysis techniques, such as, but not limited to, scanning electron microscopy or dynamic light scattering. D₉₀ includes the characteristic dimension at which 90% of the particles are smaller than the recited size.

As used herein, a “thickness” by which is film is characterized refers to the distance, or median measured distance, between the top and bottom faces of a film. As used herein, the top and bottom faces refer to the sides of the film having the largest surface area.

As used herein, the phrase “subscripts and molar coefficients in the empirical formulas are based on the quantities of raw materials initially batched to make the described examples” means the subscripts, (e.g., 7, 3, 2, 12 in Li₇La₃Zr₂O₁₂ and the coefficient 0.35 in 0.35Al₂O₃) refer to the respective elemental ratios in the chemical precursors (e.g., LiOH, La₂O₃, ZrO₂, Al₂O₃) used to prepare a given material, (e.g., Li₇La₃Zr₂O₁₂·0.35Al₂O₃).

As used herein the phrase “sintering the film,” refers to a process whereby a thin film, as described herein, is densified (made denser, or made with a reduced porosity) through the use of heat sintering or field assisted sintering. Sintering includes the process of forming a solid mass of material by heat and/or pressure without melting it to the point of complete liquification.

As used herein, the term “plasticizer” refers to an additive that imparts either flexibility or plasticity to the green tape. It may be a substance or material used to increase the binder's flexibility, workability, or distensibility. Flexibility is the ability to bend without breaking. Plasticity is the ability to permanently deform.

As used herein, the phrase “stress relieving,” refers to a process which eliminates residual stress in a casted green tape during drying and associated shrinkage. One method of stress relieving includes heating the green tape at a temperature above the glass transition temperature of the organic components in the green tape to allow structural and stress rearrangement in the casted green tape to eliminate residual stress. Another method of stress relieving includes heating a casted green tape to 70° C. and holding at that temperature for a minute to allow casted green tape to relieve stress.

As used herein, the phrase “pH modifier,” refers to an acid or a base that can be added to a slurry to adjust the acidity or basicity of the slurry in order to achieve better dispersion stability of cast slurry. pH modifiers include, but are not limited to, citric acid and ammonia hydroxide, as well as other equivalent pH modifiers.

As used herein, the phrase “as batched,” refers to the respective molar amounts of components as initially mixed or provided at the beginning of a synthesis. For example, the formula Li₇La₃Zr₂O₁₂, as batched, means that the ratio of Li to La to Zr to O in the reagents used to make Li₇La₃Zr₂O₁₂ was 7 to 3 to 2 to 12.

As used herein, a picnometry density is measured using a Micromeritics AccuPycII 1340 Calibrate instrument. Using this instrument, a controlled amount of a powder sample is placed in a cup and its mass measured. The instrument is used to measure volume and calculate density by mass/volume.

As used herein, the phrase “sintering aid,” refers to an additive that is used to either form lower the melting point of a liquid phase or that allows for faster sintering than otherwise would be possible without the sintering add. Sintering aids assist in the diffusion/kinetics of atoms being sintered. For example, LiAlO₂ may be used as an additive in a slurry having garnet since the LiAlO₂ can form a liquid with the garnet at between about 1050 and 1100° C., which provides for faster densification of garnet during sintering.

As used herein, a particle size distribution (hereinafter “PSD”) is measured by light scattering, for example, using on a Horiba LA-950 V2 particle size analyzer in which the solvents used for the analysis include toluene, IPA, or acetonitrile and the analysis includes a one-minute sonication before measurement.

As used herein, the phrase “source powder” refers to an inorganic material used in a slurry set forth herein. In some examples, the source powder is a lithium-stuffed garnet. For example, the source powder may include a powder of Li₇La₃Zr₂O₁₂·0.5Al₂O₃.

As used herein, the phrase “phosphate ester,” refers to, for example, phosphate esters known as Hypermer KD-23™, Hypermer KD-24™, Phoschem PD™, Phoschem R-6™, Phospholan PS-131™, and Rhodoline 4188™.

As used herein, the term “DBP” refers to the chemical having the formula C₁₆H₂₂O₄, Dibutyl phthalate, having a Molecular weight of 278.35 g/mol.

As used herein, the term “BBP,” refers to benzyl butyl phthalate, C₁₉H₂₀O₄, and having a Molecular weight of 312.37 g/mol.

As used herein, the term “PEG,” refers to polyethylene glycol. Unless otherwise specified, the molecular weight of the PEG is from 400 to 6000 g/mol.

### B. GREEN TAPES

In some examples set forth herein, the green tapes casted by the methods set forth herein contain refractory and, or, ceramic materials that are formulated as ceramic particles intimately mixed with a binder. The purpose of this binder is, in part, to assist the sintering of the ceramic particles to result in a uniform and thin film, or layer, of refractory or ceramic post-sintering. During the sintering process, the binder burns (e.g., calcination) out of the sintering thin film. In some examples, this binder burns out of the sintering film at a temperature less than 700° C., less than 450° C., less than 400° C., less than 350° C., less than 300° C., less than 250° C., or in some examples less than 200° C., or in some examples less than 150° C., or in some examples less than 100° C. During the binder removal, the oxygen and water partial pressures may be controlled.

### C. METHOD OF MAKING

The composites set forth herein can be made by a variety of methods. In some methods a slurry containing a source powder is prepared, this slurry is cast onto a substrate or a setter plate, and then this slurry is dried and sintered to prepare a dried and sintered solid ion conducting ceramic. In certain examples, the substrate may include, for example, Mylar, silicone coated Mylar, surfaces coated with polymers, surface modified polymers, or surface assembled monolayers adhered, attached, or bonded to a surface.

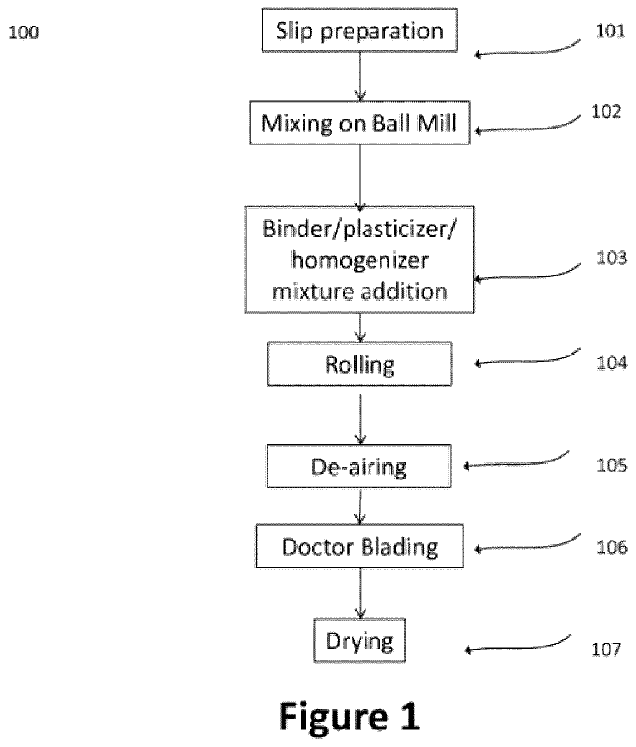

In one example, the methods set forth herein are substantially as set forth in FIG. 1. In FIG. 1, Method 100 is described. In this method, the first step includes slip preparation 101. This entails combining a solvent, dispersant, and a source powder such as garnet into a reaction container (e.g., a 50 ml Nalgene bottle). Milling media is also added. In step 102, the combined contents are milled for 1 hour to 3 days. In the third step 103, the binder, plasticizer, and or, homogenizers are added to the reaction container to form a slurry. In the fourth step 104, the slurry is rolled by rolling the reaction container to blend the binder. In the fifth step 105, the slurry is de-aired by a de-airing process to remove gas. In the sixth step 106, the slurry is cast by a doctor blade cast method onto a substrate (e.g., silicone coated Mylar). In the seventh step 107, the cast film is dried. In this step 107, the drying is accomplished in a controlled fashion to avoid cracking or defect formation in the film. In one example, the slurry included 70 g of garnet powder that had a d₅₀ of approximately 3 μm, 16 g of MEK solvent, 1.4 g of phosphate ester, 8.4 g of poly methyl methacrylate binder in 50% by weight (w/w) MEK, 3.5 g of a plasticizer (e.g., S-160), and 1.6 g of cyclohexanone.

### D. SLURRY

In some examples, the binders suitable for use with the slurries described herein include binders, used to facilitate the adhesion between the Li-stuffed garnet particles, include, but are not limited to, polypropylene (PP), polyvinyl butyral (PVB), poly ethyl methacrylate (PEMA), polyvinyl pyrrolidone (PVP), atactic polypropylene (aPP), isotactive polypropylene ethylene propylene rubber (EPR), ethylene pentene copolymer (EPC), polyisobutylene (PIB), styrene butadiene rubber (SBR), polyolefins, polyethylene-copoly-1-octene (PE-co-PO); PE-co-poly(methylene cyclopentane) (PE-co-PMCP); stereo block polypropylenes, polypropylene polymethylpentene copolymer, poly propylene carbonate, methyl methacrylate (or PMMA), ethyl methacrylate (or PEMA), and silicone. Other binders include binder is selected polypropylene (PP), atactic polypropylene (aPP), isotactic polypropylene (iPP), ethylene propylene rubber (EPR), ethylene pentene copolymer (EPC), polyisobutylene (PIB), styrene butadiene (SBR), polyolefins, polyethylene-co-poly-1-octene (PE-co-PO), PE-co-poly(methylene cyclopentene) (PE-co-PMCP), stereoblock polypropylenes, polypropylene polymethyl pentene, polyethylene oxide (PEO), PEO block copolymers, silicone, and combinations thereof.

Examples of dispersants, include, but are not limited to, phosphate esters, esters such as fish oil, surfactants, fluorosurfactants, polyvinylpyridine (PVP), polyvinyl butadiene (PVB), polyalkylene amine, acrylic polymers.

In some examples, the slurry may also include a surfactant. A non-limiting list of suitable surfactants includes cetylpyridinium chloride, cetylpyridium bromide, and sodium dodecylbenzenesulfonate.

In some examples, the slurry may also include a pH modifier. Example pH modifiers include, but are not limited to, glacial acetic acid, NH₄OH, monoethanol amine, NaOH, Na₂CO₃, and KOH.

In some examples, the slurry may also include a plasticizer. Example plasticizers include, but are not limited to, dibutyl phthalate, dioctyl phthalate, and benzyl butyl phthalate.

In some examples, the slurry includes Li garnet powders or precursors that strongly interact with solvents or organic binders and which increase slurry viscosity via re-flocculation. In some examples, the re-flocculation is at a high level that does not result in high quality slurries and casted tapes. In these particular examples, the process can be controlled by the addition of an agent which changes the pH of the slurry so that it has a stable dispersion in the slurry. In these particular examples, the process can also controlled by the addition of less reactive solvents and, or, binders. In these examples, the slurries have good dispersion, low viscosity and minimal organic content.

### E. CASTING

Some tape casting methods are known in the relevant filed and include those set forth in Mistler, R. E. and Twiname, E. R, Tape Casting: Theory and Practice, 1^{st} Edition Wiley-American Ceramic Society; 1 edition (Dec. 1, 2000), the entire contents of which is herein incorporated by reference in its entirety for all purposes. Other casting methods and materials as set forth in U.S. Pat. No. 5,256,609, to Dolhert, L. E., and entitled CLEAN BURNING GREEN TAPE CAST SYSTEM USING ATACTIC POLYPROPYLENE BINDER), the entire contents of which is herein incorporated by reference in its entirety for all purposes.

In some methods set forth herein, the methods include casting a tape of ceramic source powder onto a substrate (e.g., porous or nonporous alumina, zirconia, garnet, alumina-zirconia, lanthanum alumina-zirconia). In some examples, the tape is prepared on a substrate such as a silicone coated substrate (e.g., silicone coated Mylar, or silicone coated Mylar on alumina).

In some methods set forth herein, the sintering films release volatile components. These components can often result in cracking or surface deterioration in the sintering film unless setter plates are used which allow for these volatile components to evaporate or volatilize away from the sintering film. In some particular examples, it is advantageous to use a porous setter plate to assist with the evaporation of these volatile components.

### F. TAPE DRYING AFTER CASTING

In some examples, the methods set forth herein include drying a casted tape (e.g., a green film). In some methods, drying includes controlling the temperature of the casted tape by, for example, using a heated bed on which to place or deposit the casted film, infrared (IR) heating, or convection heating of the casted tape. In some methods, drying may include using environmental controls such as, but not limited to, stagnant and, or, flowing environment (e.g., atmospheric air, dry air, inert gas, nitrogen gas, argon gas) to manage or to control the amount of solvent in the drying ambient. In these methods, the drying is used to control the rate of solvent removal and to ensure that the cast film dries from the substrate to the surface as opposed to from the surface to the substrate.

In some examples, prior to drying the cast green tape, the cast green tape includes a solvent which is an azeotrope. In some examples, this azeotrope is a solvent comprises cyclohexanone at 10-25 weight % of the green tape. In some examples, the weight percent of cyclohexanone in the azeotrope is 10 weight %. In some examples, the weight percent of cyclohexanone in the azeotrope is 11 weight %. In some examples, the weight percent of cyclohexanone in the azeotrope is 12 weight %. In some examples, the weight percent of cyclohexanone in the azeotrope is 13 weight %. In some examples, the weight percent of cyclohexanone in the azeotrope is 14 weight %. In some examples, the weight percent of cyclohexanone in the azeotrope is 15 weight %. In some examples, the weight percent of cyclohexanone in the azeotrope is 16 weight %. In some examples, the weight percent of cyclohexanone in the azeotrope is 17 weight %. In some examples, the weight percent of cyclohexanone in the azeotrope is 18 weight %. In some examples, the weight percent of cyclohexanone in the azeotrope is 19 weight %. In some examples, the weight percent of cyclohexanone in the azeotrope is 20 weight %. In some examples, the weight percent of cyclohexanone in the azeotrope is 21 weight %. In some examples, the weight percent of cyclohexanone in the azeotrope is 22 weight %. In some examples, the weight percent of cyclohexanone in the azeotrope is 23 weight %. In some examples, the weight percent of cyclohexanone in the azeotrope is 24 weight %. In some examples, the weight percent of cyclohexanone in the azeotrope is 25 weight %. In some examples, the solvent is a combination of MEK:IPA. In certain examples, the ratio of MEK:IPA is 1:1. In certain examples, the ratio of MEK:IPA is 2:1. In certain examples, the ratio of MEK:IPA is 3:1. In certain examples, the ratio of MEK:IPA is 4:1. In certain examples, the ratio of MEK:IPA is 5:1. In certain examples, the ratio of MEK:IPA is 5:1. n certain examples, the ratio of MEK:IPA is 7:1. In certain examples, the ratio of MEK:IPA is 8:1. In certain examples, the ratio of MEK:IPA is 5:1. In certain examples, the ratio of MEK:IPA is 5:2. In certain examples, the ratio of MEK:IPA is 6:2. In certain examples, the ratio of MEK:IPA is 7:2. In certain examples, the ratio of MEK:IPA is 8:2. In certain examples, the ratio of MEK:IPA is 9:2. In certain examples, the ratio of MEK:IPA is 10:3. In certain examples, the ratio of MEK:IPA is 11:3. In certain examples, the ratio of MEK:IPA is 5:3. In certain examples, the ratio of MEK:IPA is 6:3. In certain examples, the ratio of MEK:IPA is 7:3. In certain examples, the ratio of MEK:IPA is 8:3. In certain examples, the ratio of MEK:IPA is 9:3. In certain examples, the ratio of MEK:IPA is 10:3. In certain examples, the ratio of MEK:IPA is 11:3.

In some examples, after the green tape is dried, the total amount of material other than the source powder is about 10-25% by weight of the green tape. In some examples the total amount of material other than the source powder is 10% by weight of the green tape. In some examples the total amount of material other than the source powder is 11% by weight of the green tape. In some examples the total amount of material other than the source powder is 12% by weight of the green tape. In some examples the total amount of material other than the source powder is 13% by weight of the green tape. In some examples the total amount of material other than the source powder is 14% by weight of the green tape. In some examples the total amount of material other than the source powder is 15% by weight of the green tape. In some examples the total amount of material other than the source powder is 16% by weight of the green tape. In some examples the total amount of material other than the source powder is 17% by weight of the green tape. In some examples the total amount of material other than the source powder is 18% by weight of the green tape. In some examples the total amount of material other than the source powder is 19% by weight of the green tape. In some examples the total amount of material other than the source powder is 20% by weight of the green tape. In some examples the total amount of material other than the source powder is 21% by weight of the green tape. In some examples the total amount of material other than the source powder is 22% by weight of the green tape. In some examples the total amount of material other than the source powder is 23% by weight of the green tape. In some examples the total amount of material other than the source powder is 24% by weight of the green tape. In some examples the total amount of material other than the source powder is 25% by weight of the green tape. In some of these examples, the amount of source powder is 60, 65, 70, 75, or 80% be weight fo the green tape.

### G. SETTER PLATES

In the methods described herein, the setter plates and the sintering methods set forth in International PCT Patent Applications Nos. PCT/US16/27886, filed on Apr. 15, 2016, and PCT/US16/27922, filed on Apr. 15, 2016, the content of both patent applications is incorporated herein by reference in its entirety for all purposes.

In some examples, the green films prepared by the methods herein, and those incorporated by reference, are sintered between setter plates. In some examples, these setter plates are composed of a metal, an oxide, a nitride, a metal, oxide or nitride with an organic or silicone laminate layer thereupon. In certain examples, the setter plates are selected from the group consisting of platinum (Pt) setter plates, palladium (Pd) setter plates, gold (Au) setter plates, copper (Cu) setter plates, aluminum (Al) setter plates, alumina setter plates, porous alumina setter plates, steel setter plates, zirconium (Zr) setter plates, zirconia setter plates, porous zirconia setter plates, lithium oxide setter plates, porous lithium oxide setter plates, lanthanum oxide setter plates, porous lanthanum oxide setter plates, garnet setter plates, porous garnet setter plates, lithium-stuffed garnet setter plates, porous lithium-stuffed garnet setter plates, and combinations thereof. In some examples, the setter plates are garnet setter plates or porous garnet setter plates.

In some examples, the green films prepared by the methods herein, and those incorporated by reference, are sintered on at least one setter plate. In some examples, these setter plates are composed of a metal, an oxide, a nitride, a metal, oxide or nitride with an organic or silicone laminate layer thereupon. In certain examples, the setter plates are selected from the group consisting of platinum (Pt) setter plates, palladium (Pd) setter plates, gold (Au) setter plates, copper (Cu) setter plates, aluminum (Al) setter plates, alumina setter plates, porous alumina setter plates, steel setter plates, zirconium (Zr) setter plates, zirconia setter plates, porous zirconia setter plates, lithium oxide setter plates, porous lithium oxide setter plates, lanthanum oxide setter plates, Lithium zirconium oxide (Li₂ZrO₃) setter plates, Lithium aluminum oxide (LiAlO₂) setter plates, porous lanthanum oxide setter plates, garnet setter plates, porous garnet setter plates, lithium-stuffed garnet setter plates, porous lithium-stuffed garnet setter plates, and combinations of the aforementioned.

In some examples, the green films prepared by the methods herein, and those incorporated by reference, are sintered between setter plates in which a metal powder is positioned between the setter plate and the green film. In some examples, these setter plates are composed of a metal, an oxide, a nitride, a metal, oxide or nitride with an organic or silicone laminate layer thereupon. In certain examples, the setter plates are selected from the group consisting of platinum (Pt) setter plates, palladium (Pd) setter plates, gold (Au) setter plates, copper (Cu) setter plates, aluminum (Al) setter plates, alumina setter plates, porous alumina setter plates, steel setter plates, zirconium (Zr) setter, zirconia setter plates, porous zirconia setter plates, lithium oxide setter plates, porous lithium oxide setter plates, lanthanum oxide setter plates, Lithium zirconium oxide (Li₂ZrO₃) setter plates, Lithium aluminum oxide (LiAlO₂) setter plates, porous lanthanum oxide setter plates, Lithium zirconium oxide (Li₂ZrO₃) setter plates, Lithium aluminum oxide (LiAlO₂) setter plates, garnet setter plates, porous garnet setter plates, lithium-stuffed garnet setter plates, and porous lithium-stuffed garnet setter plates, and combinations of the aforementioned. In these particular examples, the metal powder is selected from Ni power, Cu powder, Au powder, Fe powder, or combinations thereof.

In some examples, the green films prepared by the methods herein, and those incorporated by reference, are sintered between setter plates in which a metal layer or film is positioned between the setter plate and the green film. In some examples, these setter plates are composed of a metal, an oxide, a nitride, a metal, oxide or nitride with an organic or silicone laminate layer thereupon. In certain examples, the setter plates are selected from the group consisting of platinum (Pt) setter plates, palladium (Pd) setter plates, gold (Au) setter plates, copper (Cu) setter plates, aluminum (Al) setter plates, alumina setter plates, porous alumina setter plates, steel setter plates, zirconium (Zr), zirconia setter plates, porous zirconia setter plates, lithium oxide setter plates, porous lithium oxide setter plates, lanthanum oxide setter plates, porous lanthanum oxide setter plates, garnet setter plates, porous garnet setter plates, lithium-stuffed garnet setter plates, porous lithium-stuffed garnet setter plates, magnesia setter plates, porous magnesia setter plates. In these particular examples, the metal powder is selected from Ni power, Cu powder, Mg powder, Mn power, Au powder, Fe powder, or combinations thereof.

During certain sintering conditions, a layer of particles (e.g., a setter sheet) or powder may be placed between the green film and the setter plates to assist with the sintering of the green film. As the green film sinters, it tends to shrink and densify which if not controlled can lead to cracking or other mechanical defects in the film. In some of these examples, the layer of particles comprises a uniform layer of particles. In some other of these examples, the layer of particles comprises a uniform layer of inert, or non-reactive with the green film, particles. In some sintering conditions, the layer of particles is provided as a sheet of particles. In some examples, the thickness of the sheet or layer or particles is about equal to the size of the particles in the sheet or layer. In other examples, the inert particles positions between the green film and the setter plate(s) is positioned between the contact surfaces of the green film and the parts of the green film which are being sintered. In some continuous sintering processes, the setter plates and, or, the particles, layers, or sheets which are placed between the setter plates and the green film, may be moved or repositioned during the sintering process so that a continuous roll of sintered film is prepared in a continuous process. In these continuous processes, the setter plates and the particles, layers, or sheets, move in conjunction with the movement of the green film so that the portion of the green film being sintering is in contact with the particles, layers, or sheets which are also in contact with the setter plates. In some instances, the layers or sheets are prepared with a particular weight to prevent tape warping and surface deterioration.

In some of the examples described herein, the layer or sheet of inert and, or, uniform particles (or powders) assists the sintering process by providing a minimal amount of friction between the film and the setter plates so that the film is not strained as it sinters and reduces in volume and increases in density. By reducing the friction forces on the film, the green film can shrink with minimal stress during the sintering process. This provides for improved sintered films that do not stick to the setter plates, which do not distort during the sintering process, and which do not crack during the sintering process or thereafter.

In some examples described herein, other setter plates may be used, for example in combination with the lithium stuffed garnet setter plates described herein, so long as that other setter plate has a high melting point, a high lithium activity, and a stability in reducing environment. Some examples of these other materials include a member selected from Li₂ZrO₃, xLi₂O-(1−x)SiO₂ (where x=0.01-0.99), aLi₂O-bB₂O₃-cSiO₂ (where a+b+c=1), LiLaO₂, LiAlO₂, Li₂O, Li₃PO₄, a Li-stuffed garnet, or combinations thereof. Additionally, these other setter plates should not induce a chemical potential in the sintering film which results in Li diffusion out of the sintering film and into the setter plate. Additional materials include lanthanum aluminum oxide, pyrochlore and materials having a lithium concentration of greater than 0.01 mol/cm³. In some examples, the setter material may be provided as a powder or in a non-planar shape.

### H. SOLVENTS

In some examples, the slurry includes a solvent selected from isopropanol, water, butanol, tetrahydrofuran (THF), optionally with a binder (e.g., PVB), and optionally with a plasticizer. In some examples, the solvent includes about 10-30% w/w isopropanol, 1-10% w/w water, 1-10% w/w butanol, and 10-30% w/w tetrahydrofuran (THF) [e.g. 100 grams garnet, 12 grams binder, 12 grams DBP, 20-30 grams solvent]. In some examples, the solvent includes about 20-30% w/w isopropanol, 3-6% w/w water, 3-6% w/w butanol, and 20-30% w/w tetrahydrofuran (THF). In some examples, the binder is 5% w/w. In some examples, the plasticizer is 5% w/w. In these examples, the garnet or calcined precursor materials represents the remaining % w/w (e.g., 40, 50, 60%, 70%, or 75% w/w). In some examples, a dispersant is used during the milling process. In some examples, the dispersant is a phosphate ester. In some examples, the plasticizer is dibutyl thalate or benzyl butyl phthalate. In some examples, the solvent is butanol and THF. In some examples, the solvent is butanol, water and THF. In some examples, the solvent is butanol, water, toluene, and THF. In some examples, the solvent is butanol and toluene. In some examples, the solvent is butanol, water and THF.

Examples of solvents include toluene, ethanol, diacetone alcohol, and combinations thereof. Other examples of solvents include combinations of isopropanol (IPA, anhydrous), butanol, and toluene. Other examples of solvents include methanol, ethanol, isopropanol, butanol, pentanol, hexanol, toluene, xylene, xylenes: butyl alcohol, cyclohexanone, tetrahydrofuran, toluene: ethanol, acetone, N-methyl-2-pyrrolidone (NMP) diacetone alcohol, ethyl acetate, acetonitrile, hexane, nonane, dodecane, methyl ethyl ketone (MEK), and combinations thereof.

In some examples, the solvent is a combination of MEK:IPA. In certain examples, the ratio of MEK:IPA is 1:1. In certain examples, the ratio of MEK:IPA is 2:1. In certain examples, the ratio of MEK:IPA is 3:1. In certain examples, the ratio of MEK:IPA is 4:1. In certain examples, the ratio of MEK:IPA is 5:1. In certain examples, the ratio of MEK:IPA is 5:1. n certain examples, the ratio of MEK:IPA is 7:1. In certain examples, the ratio of MEK:IPA is 8:1. In certain examples, the ratio of MEK:IPA is 5:1. In certain examples, the ratio of MEK:IPA is 5:2. In certain examples, the ratio of MEK:IPA is 6:2. In certain examples, the ratio of MEK:IPA is 7:2. In certain examples, the ratio of MEK:IPA is 8:2. In certain examples, the ratio of MEK:IPA is 9:2. In certain examples, the ratio of MEK:IPA is 10:3. In certain examples, the ratio of MEK:IPA is 11:3. In certain examples, the ratio of MEK:IPA is 5:3. In certain examples, the ratio of MEK:IPA is 6:3. In certain examples, the ratio of MEK:IPA is 7:3. In certain examples, the ratio of MEK:IPA is 8:3. In certain examples, the ratio of MEK:IPA is 9:3. In certain examples, the ratio of MEK:IPA is 10:3. In certain examples, the ratio of MEK:IPA is 11:3.

In of the above examples, the solvent further comprises cyclohexanone at 10-25 weight %. In some examples, the weight percent of cyclohexanone in the slurry is 10 weight %. In some examples, the weight percent of cyclohexanone in the slurry is 11 weight %. In some examples, the weight percent of cyclohexanone in the slurry is 12 weight %. In some examples, the weight percent of cyclohexanone in the slurry is 13 weight %. In some examples, the weight percent of cyclohexanone in the slurry is 14 weight %. In some examples, the weight percent of cyclohexanone in the slurry is 15 weight %. In some examples, the weight percent of cyclohexanone in the slurry is 16 weight %. In some examples, the weight percent of cyclohexanone in the slurry is 17 weight %. In some examples, the weight percent of cyclohexanone in the slurry is 18 weight %. In some examples, the weight percent of cyclohexanone in the slurry is 19 weight %. In some examples, the weight percent of cyclohexanone in the slurry is 20 weight %. In some examples, the weight percent of cyclohexanone in the slurry is 21 weight %. In some examples, the weight percent of cyclohexanone in the slurry is 22 weight %. In some examples, the weight percent of cyclohexanone in the slurry is 23 weight %. In some examples, the weight percent of cyclohexanone in the slurry is 24 weight %. In some examples, the weight percent of cyclohexanone in the slurry is 25 weight %. In some examples, the solvent is a combination of MEK:IPA. In certain examples, the ratio of MEK:IPA is 1:1. In certain examples, the ratio of MEK:IPA is 2:1. In certain examples, the ratio of MEK:IPA is 3:1. In certain examples, the ratio of MEK:IPA is 4:1. In certain examples, the ratio of MEK:IPA is 5:1. In certain examples, the ratio of MEK:IPA is 5:1. n certain examples, the ratio of MEK:IPA is 7:1. In certain examples, the ratio of MEK:IPA is 8:1. In certain examples, the ratio of MEK:IPA is 5:1. In certain examples, the ratio of MEK:IPA is 5:2. In certain examples, the ratio of MEK:IPA is 6:2. In certain examples, the ratio of MEK:IPA is 7:2. In certain examples, the ratio of MEK:IPA is 8:2. In certain examples, the ratio of MEK:IPA is 9:2. In certain examples, the ratio of MEK:IPA is 10:3. In certain examples, the ratio of MEK:IPA is 11:3. In certain examples, the ratio of MEK:IPA is 5:3. In certain examples, the ratio of MEK:IPA is 6:3. In certain examples, the ratio of MEK:IPA is 7:3. In certain examples, the ratio of MEK:IPA is 8:3. In certain examples, the ratio of MEK:IPA is 9:3. In certain examples, the ratio of MEK:IPA is 10:3. In certain examples, the ratio of MEK:IPA is 11:3.

In some examples, the solvent in the slurry includes MEK:IPA and cyclohexanone. In certain examples, the weight percent of cyclohexanone in the slurry is 10 weight %. In some examples, the weight percent of cyclohexanone in the slurry is 11 weight %. In some examples, the weight percent of cyclohexanone in the slurry is 12 weight %. In some examples, the weight percent of cyclohexanone in the slurry is 13 weight %. In some examples, the weight percent of cyclohexanone in the slurry is 14 weight %. In some examples, the weight percent of cyclohexanone in the slurry is 15 weight %. In some examples, the weight percent of cyclohexanone in the slurry is 16 weight %. In some examples, the weight percent of cyclohexanone in the slurry is 17 weight %. In some examples, the weight percent of cyclohexanone in the slurry is 18 weight %. In some examples, the weight percent of cyclohexanone in the slurry is 19 weight %. In some examples, the weight percent of cyclohexanone in the slurry is 20 weight %. In some examples, the weight percent of cyclohexanone in the slurry is 21 weight %. In some examples, the weight percent of cyclohexanone in the slurry is 22 weight %. In some examples, the weight percent of cyclohexanone in the slurry is 23 weight %. In some examples, the weight percent of cyclohexanone in the slurry is 24 weight %. In some examples, the weight percent of cyclohexanone in the slurry is 25 weight %. In some examples, the solvent is a combination of MEK:IPA. In certain examples, the ratio of MEK:IPA is 1:1. In certain examples, the ratio of MEK:IPA is 2:1. In certain examples, the ratio of MEK:IPA is 3:1. In certain examples, the ratio of MEK:IPA is 4:1. In certain examples, the ratio of MEK:IPA is 5:1. In certain examples, the ratio of MEK:IPA is 5:1. n certain examples, the ratio of MEK:IPA is 7:1. In certain examples, the ratio of MEK:IPA is 8:1. In certain examples, the ratio of MEK:IPA is 5:1. In certain examples, the ratio of MEK:IPA is 5:2. In certain examples, the ratio of MEK:IPA is 6:2. In certain examples, the ratio of MEK:IPA is 7:2. In certain examples, the ratio of MEK:IPA is 8:2. In certain examples, the ratio of MEK:IPA is 9:2. In certain examples, the ratio of MEK:IPA is 10:3. In certain examples, the ratio of MEK:IPA is 11:3. In certain examples, the ratio of MEK:IPA is 5:3. In certain examples, the ratio of MEK:IPA is 6:3. In certain examples, the ratio of MEK:IPA is 7:3. In certain examples, the ratio of MEK:IPA is 8:3. In certain examples, the ratio of MEK:IPA is 9:3. In certain examples, the ratio of MEK:IPA is 10:3. In certain examples, the ratio of MEK:IPA is 11:3.

In certain examples, the ratio of MEK:IPA is 7:3

In some examples, the solvent is a combination of MEK, IPA, and cyclohexanone.

In some examples, the solvent herein further includes water.

### I. SINTERING

The green films set forth herein can be sintered by sintering methods known in the relevant field. The sintering conditions set forth in PCT/US2014/059578, Garnet Materials for Li Secondary Batteries and Methods of Making and Using Garnet Materials, filed Oct. 7, 2014, are herein incorporated by reference in their entirety for all purposes.

The green films set forth herein can be sintered in ovens open to the atmosphere. In some examples, the films are sintered in an O₂ rich atmosphere. In other examples, the films are sintered in an Argon rich atmosphere. In yet other examples, the films are sintered in an Argon/H₂ atmosphere. In other examples, the films are sintered in an Argon/H₂O atmosphere. In some examples, the atmosphere used to sinter the films is not the same as the atmosphere used to cool the films after they have been sintered.

In some examples, the method includes sintering the film, wherein sintering comprises heat sintering. In some of these examples, heat sintering includes heating the film in the range from about 700° C. to about 1200° C. for about 1 to about 600 minutes and in atmosphere having an oxygen partial pressure in the range of 1e-1 atm to 1e-15 atm.

In any of the methods set forth herein, heat sintering may include heating the film in the range from about 700° C. to about 1250° C.; or about 800° C. to about 1200° C.; or about 900° C. to about 1200° C.; or about 1000° C. to about 1200° C.; or about 1100° C. to about 1200° C. In any of the methods set forth herein, heat sintering can include heating the film in the range from about 700° C. to about 1100° C.; or about 700° C. to about 1000° C.; or about 700° C. to about 900° C.; or about 700° C. to about 800° C. In any of the methods set forth herein, heat sintering can include heating the film to about 700° C., about 750° C., about 850° C., about 800° C., about 900° C., about 950° C., about 1000° C., about 1050° C., about 1100° C., about 1150° C., or about 1200° C. In any of the methods set forth herein, heat sintering can include heating the film to 700° C., 750° C., 850° C., 800° C., 900° C., 950° C., 1000° C., 1050° C., 1100° C., 1150° C., or 1200° C. In any of the methods set forth herein, heat sintering can include heating the film to 700° C. In any of the methods set forth herein, heat sintering can include heating the film to 750° C. In any of the methods set forth herein, heat sintering can include heating the film to 850° C. In any of the methods set forth herein, heat sintering can include heating the film to 900° C. In any of the methods set forth herein, heat sintering can include heating the film to 950° C. In any of the methods set forth herein, heat sintering can include heating the film to 1000° C. In any of the methods set forth herein, heat sintering can include heating the film to 1050° C. In any of the methods set forth herein, heat sintering can include heating the film to 1100° C. In any of the methods set forth herein, heat sintering can include heating the film to 1125° C. In any of the methods set forth herein, heat sintering can include heating the film to 1150° C. In any of the methods set forth herein, heat sintering can include heating the film to 1200° C.

In any of the methods set forth herein, the methods may include heating the film for about 1 to about 600 minutes. In any of the methods set forth herein, the methods may include heating the film for about 20 to about 600 minutes. In any of the methods set forth herein, the methods may include heating the film for about 30 to about 600 minutes. In any of the methods set forth herein, the methods may include heating the film for about 40 to about 600 minutes. In any of the methods set forth herein, the methods may include heating the film for about 50 to about 600 minutes. In any of the methods set forth herein, the methods may include heating the film for about 60 to about 600 minutes. In any of the methods set forth herein, the methods may include heating the film for about 70 to about 600 minutes. In any of the methods set forth herein, the methods may include heating the film for about 80 to about 600 minutes. In any of the methods set forth herein, the methods may include heating the film for about 90 to about 600 minutes. In any of the methods set forth herein, the methods may include heating the film for about 100 to about 600 minutes. In any of the methods set forth herein, the methods may include heating the film for about 120 to about 600 minutes. In any of the methods set forth herein, the methods may include heating the film for about 140 to about 600 minutes. In any of the methods set forth herein, the methods may include heating the film for about 160 to about 600 minutes. In any of the methods set forth herein, the methods may include heating the film for about 180 to about 600 minutes. In any of the methods set forth herein, the methods may include heating the film for about 200 to about 600 minutes. In any of the methods set forth herein, the methods may include heating the film for about 300 to about 600 minutes. In any of the methods set forth herein, the methods may include heating the film for about 350 to about 600 minutes. In any of the methods set forth herein, the methods may include heating the film for about 400 to about 600 minutes. In any of the methods set forth herein, the methods may include heating the film for about 450 to about 600 minutes. In any of the methods set forth herein, the methods may include heating the film for about 500 to about 600 minutes. In any of the methods set forth herein, the methods may include heating the film for about 1 to about 500 minutes. In any of the methods set forth herein, the methods may include heating the film for about 1 to about 400 minutes. In any of the methods set forth herein, the methods may include heating the film for about 1 to about 300 minutes. In any of the methods set forth herein, the methods may include heating the film for about 1 to about 200 minutes. In any of the methods set forth herein, the methods may include heating the film for about 1 to about 100 minutes. In any of the methods set forth herein, the methods may include heating the film for about 1 to about 50 minutes.

In some examples, the sintering process may further include a filtration step.

In some examples, the sintering process may further include a de-aeration step.

In some examples, the sintering process may include sintering within a closed, but not sealed, furnace (i.e., oven, heating chamber). In some of these examples, the sintering film is placed between setter plates, optionally with setter sheets or layers therebetween as well, and the sintering film is placed next to, or in close proximity to, a sacrificial source of Li. This sacrificial source of Li helps to prevent Li loss by way of evaporation from the sintering garnet. In some examples, the closed system includes Argon gas, a mixture of Argon gas and either Hydrogen gas or water, Air, purified Air, or Nitrogen. In some of these examples, the sacrificial source of Li has a higher surface area than the surface area of the green tape which is sintered. In some examples, the Li source and the sintering green film have the same type of lithium-stuffed garnets.

### J. SINTERING WITH OTHER DEVICE COMPONENTS

In certain examples, the green films are sintered while in contact with other components with which the post-sintered films would be combined if used in an electrochemical device. For example, in some examples, the green films are layered or laminated to a positive electrode composition so that after sintering the green film, the sintered film is adhered to the positive electrode. In another example, the green film is sintered while in contact with a metallic powder (e.g., nickel (Ni) powder). As the green film sinters, and the metal powder because a solid metal foil, the sintering film bonds to the metal foil. The advantage of these sintering conditions is that more than one component of an electrochemical device can be prepared in one step, thus saving manufacturing time and resources.

### K. MILLING

As described herein, several recited methods include methods steps related to mixing and, or, method steps related to milling. Milling includes ball milling. Milling also includes milling methods that use inert solvents such as, but not limited to, ethanol, isopropanol, toluene, ethyl acetate, methyl acetate, acetone, acetonitrile, or combinations thereof. Depending on the material milled, the solvents may not be inert. In some of these examples, milling includes milling with solvents such as, but not limited to, ethanol, isopropanol, toluene, ethyl acetate, methyl acetate, acetone, acetonitrile, MEK, or combinations thereof.

In some examples, the milling is ball milling. In some examples, the milling is horizontal milling. In some examples, the milling is attritor milling. In some examples, the milling is immersion milling. In some examples, the milling is jet milling. In some examples, the milling is steam jet milling. In some examples, the milling is high energy milling. In some examples, the high energy milling process results in a milled particle size distribution with d₅₀ of approximately 100 nm. In some examples, the milling is immersion milling.

In some examples, high energy milling process is used to achieve a particle size distribution with d50 of about 100 nm. In some examples, the solvent is toluene. In some examples, the solvent is isopropyl alcohol (IPA). In some examples, the solvent is ethanol. In some examples, the solvent is diacetone alcohol. In some examples, the solvent is a polar solvents suitable for achieving the recited d50 size.

In some examples, the milling includes high energy wet milling process with 0.3 mm yttria stabilized zirconium oxide grinding media beads. In some examples, ball milling, horizontal milling, attritor milling, or immersion milling can be used. In some examples, using a high energy milling process produces a particle size distribution of about d50˜ 100 nm to 5000 nm.

In some examples, the milling may include a classifying step such as sieving, centrifugation, or other known laboratory of separating particles of different size and/or mass.

### L. EXAMPLES

SEM Electron microscopy was performed in a Helios 600i or FEI Quanta. Surface Roughness was measured by an optical microscope such as the Keyence VR that may measure height and calculate a roughness value.

Sintering instruments used included 3″ laboratory tube furnace with controlled atmosphere in the partial pressure oxygen range of 1e-1 to 1e-20 atm with a custom temperature and gas flow control system

### Example 1—Method for Making and Sintering a Green Tape

A first slurry was prepared which included 18.75 g of a lithium-stuffed garnet (as batched, Li_{7.1}Zr₂La₃O₁₂+0.5Al₂O₃) source powder mixed with 12.25 g of isopropanol, 1.875 g of polyvinylbutyral, 1.875 g of dibutyl phthalate, 2.81 g of phosphate ester, and 9 g of tetrahydrofuran.

A second slurry was prepared which included 18.75 g of a lithium-stuffed garnet source powder, mixed with 12.25 g of isopropanol, 1.875 g of polyvinylbutyral, 1.875 g of dibutyl phthalate, 2.81 g of phosphate ester, and 9 g of toluene.

A third slurry was prepared which included 18.75 g of a lithium-stuffed garnet source powder mixed with 12.25 g of a mixed solvent which included isopropanol and 20% by weight butanol, and 1.875 g of polyvinylbutyral, 1.875 g of dibutyl phthalate, and 2.81 g of phosphate ester, and 9 g of tetrahydrofuran.

A fourth slurry was prepared which included 18.75 g of a lithium-stuffed garnet source powder mixed with 12.25 g of a mixed solvent which included isopropanol and 20% by weight butanol, 1.875 g of polyvinylbutyral, 1.875 g of dibutyl phthalate, 2.81 g of phosphate ester, and 9 g of toluene.

The particle morphology of the lithium-stuffed garnet source powder, before and after attrition milling, for each slurry is illustrated in FIGS. 5 and 6, respectively.

In this example, a green tape was prepared by casting a slurry of lithium-stuffed garnet onto a substrate by doctor blading, subsequently sintering the cast slurry by placing it between two porous garnet setter plates, and then removed from the setter plates. In one example, the tape cast from the slurry was sintered at 1100° C. for 1-5 hours. In another example, the tape was sintered at 1125° C. for 1-5 hours. In another example, the tape was sintered at 1150° C. for 1-5 hours. Prior to the sintering, the binder was burned out in high pressure O₂ (PO₂) and H₂O. During sintering the atmosphere around the sintering film had a PO₂ in the range 0.5-10⁻²⁰ atm.

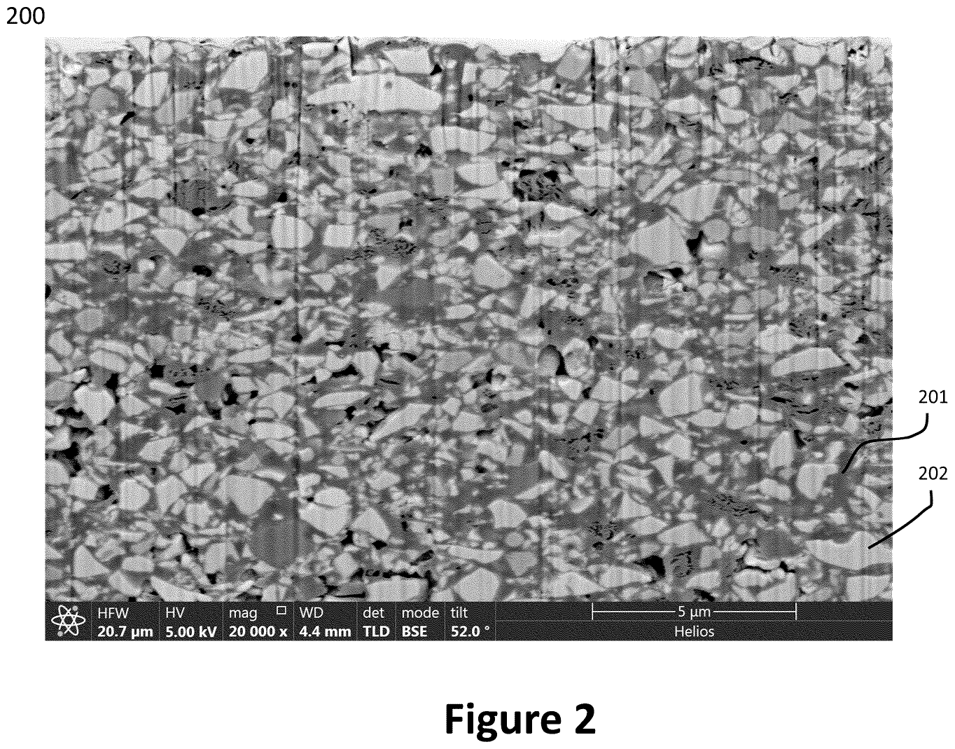

Green tape made in this example using slurry composition 1 was analyzed by SEM microscopy as set forth in FIG. 2.

### Example 2—Method for Making and Sintering a Green Tape

In this example, the following slurries (Slurry 1, Slurry 2 and Slurry 3) were prepared having the following components at the recites weight percent (%). The source powder was Li_{7.1}Zr₂La₃O₁₂+0.5Al₂O₃, as batched. “Solids” below refers to the solid content of the Rhodoline 4160.

| | density | Slurry 1 components | Slurry 2 components |
|---|---|---|---|
| Milled slurry | (g/cm3) | by weight % | by weight % |
| IPA | 0.7825 | 12.20% | 10.72% |
| Butanol | 0.81 | 3.05% | 2.68% |
| THF | 0.889 | 14.63% | 12.87% |
| Rhodoline 4160 | 1.03 | 9.15% | 6.70% |
| water | 1 | 6.86% | 5.03% |
| solids | 1.132 | 2.29% | 1.68% |
| Garnet Powder | 5.1 | 60.98% | 67.02% |

| | density | Slurry 3 components |
|---|---|---|
| Milled slurry | (g/cm3) | by weight % |
| Garnet | 4.75 | 66.40% |
| MEK | 0.805 | 13.48% |
| Ethanol | 0.789 | 13.48% |
| Rhodline 4160 | 1.1 | 6.64% |

In this example, the following binder mixtures were prepared having the following components at the recites weight percent (%):

| | density | Binder mixture 1 | Binder mixture 2 |
|---|---|---|---|
| Binder mixture | (g/cm3) | by weight % | by weight % |
| Dibutyl | 1.05 | 14.49% | 14.49% |
| phthalate | | | |
| Butvar B 79 PVB | 1.08 | 14.49% | 14.49% |
| IPA | 0.7825 | 28.99% | 18.55% |
| Butanol | 0.81 | 7.25% | 4.64% |
| THF | 0.889 | 34.78% | 22.26% |

| | density | Binder mixture 3 |
|---|---|---|
| | (g/cm3) | by weight % |
| MEK | 0.805 | 31.55% |
| Ethanol | 0.7781 | 31.55% |
| B76 | 1.083 | 22.29% |
| SANTICIZER 160 | 1.12 | 14.62% |

Slurry 1 was combined with binder mixture 1 in a 2.4 weight ratio to form a mixed slurry. Slurry 2 was combined with binder mixture 2 in a 2.1 weight ratio to form a mixed slurry. Slurry 3 was combined with binder mixture 3 in a 2. weight ratio to form a mixed slurry.

In this example, a green tape was prepared by casting each mixed slurry onto a substrate by doctor blading, subsequently sintering the cast slurry by placing it between two porous garnet setter plates, and then removed from the setter plates. In one example, the tape cast from the slurry was sintered at 1100° C. for 1-5 hours. In another example, the tape was sintered at 1125° C. for 1-5 hours. In another example, the tape was sintered at 1150° C. for 1-5 hours. Prior to the sintering, the binder was burned out in high pressure O₂ (PO₂) and H₂O. During sintering the atmosphere around the sintering film had a PO₂ in the range 0.5-10⁻²⁰ atm.

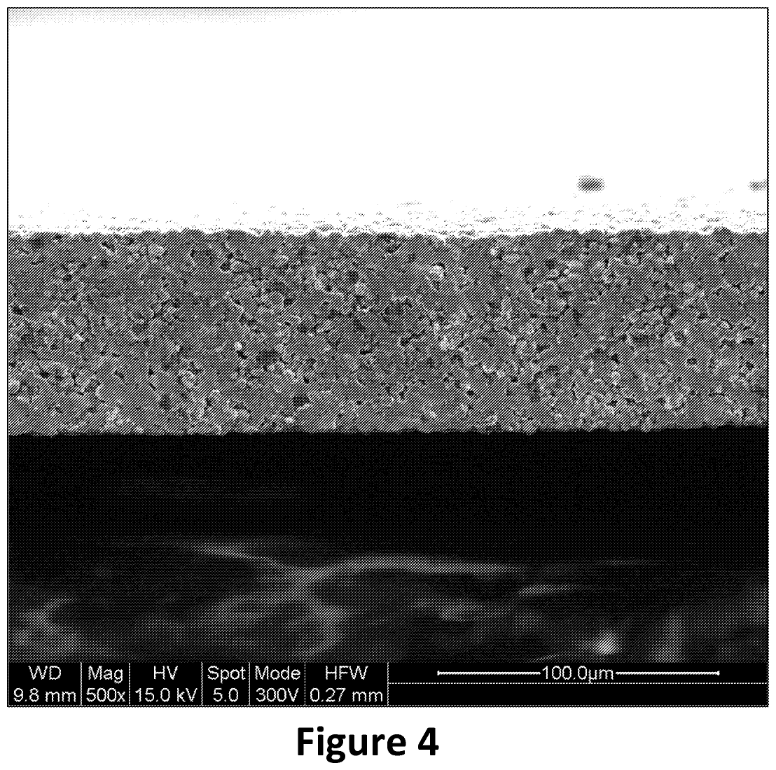

Sintered films made in this example using slurry composition 1 and binder mixture 1 were analyzed by SEM microscopy as set forth in FIG. 4.

### Example 3—Method for Layering and Sintering a Green Tape

In this example, the slurries and binder mixtures were prepared and combined as in Example 2. Next, a green tape was prepared by casting each mixed slurry onto a substrate by doctor blading. The cast mixed slurry was allowed to dry in air to form a green tape. Next, a second layer of a green tape was deposited onto the dried green tape. This process was repeated until there were five layers of green tape stacked on top of each other. Then the stacked green tapes were sintered by placing them between two porous garnet setter plates, and then removed from the setter plates. The stacked green tapes were sintered, in one example, at 1100° C. for 1-5 hours. In another example, the tape was sintered at 1125° C. for 1-5 hours. In another example, the tape was sintered at 1150° C. for 1-5 hours. Prior to the sintering, the binder was burned out in high pressure O₂ (PO₂) and H₂O. During sintering the atmosphere around the sintering film had a PO₂ in the range

0.5-10⁻²⁰ atm.

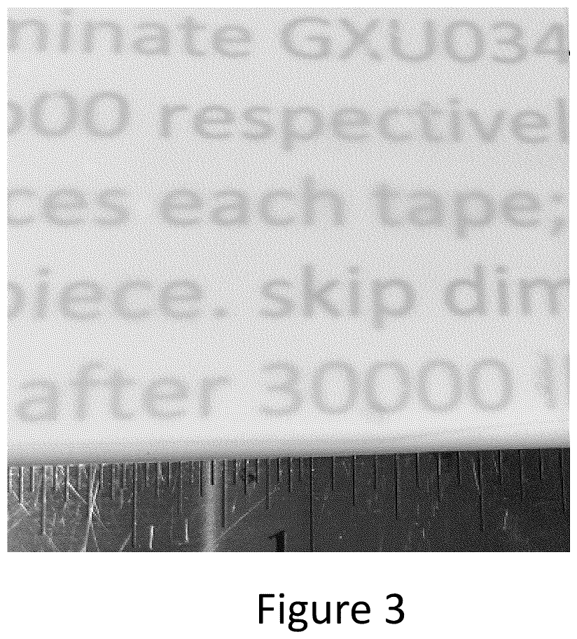

Sintered films made using the aforementioned green tapes in this example were analyzed by optical imaging as set forth in FIG. 3.

The foregoing description of the embodiments of the disclosure has been presented for the purpose of illustration; it is not intended to be exhaustive or to limit the claims to the precise forms disclosed. Persons skilled in the relevant art can appreciate that using no more than routine experimentation, numerous equivalents, modifications and variations are possible in light of the above disclosure.

What is claimed is:

1. A method for sintering a green tape, the method comprising:
(a) providing at least one source powder;
(b) modifying the at least one source powder to prepare a modified source powder;
(c) providing a slurry of the modified source powder;
(d) casting the slurry to form a green tape;
(e) drying the green tape; and
(f) sintering the green tape.

2. The method of claim 1, wherein there amount of source powder in the green tape is at least 50%, 55%, 60%, 65%, 70%, 75%, 80%, 85%, or 90% by weight.

3. The method of claim 2, wherein the amount of source powder in the green tape is at least 60% or at least 70% by weight.

4. The method any one of claims 1 to 3, wherein the at least one source powder is selected from the group consisting of lithium-stuffed garnet, chemical precursors to lithium-stuffed garnet, and lithium stuffed garnet with aluminum oxide dopants.

5. The method any one of claims 1 to 4, wherein the at least one source powder is a powder of a lithium-stuffed garnet.

6. The method any one of claims 1 to 5, wherein the at least one source powder is Li_{7.1}Zr₂La₃O₁₂+0.5Al₂O₃.

7. The method any one of claims 1 to 5, wherein the at least one source powder is lithium-stuffed garnet.

8. The method of any one of claims 1 to 5, wherein the modifying the at least one source powder comprises modifying the at least one source powder to having a particle size distribution.

9. The method of claim 8, wherein the particle size distribution is centered around 100 nm, 200 nm, 300 nm, 400 nm, 1 μm, 2 μm, 3 μm, or 4μ m.

10. The method of claim 8, wherein the particle size distribution is centered around 0.1 to 1 μm.

11. The method of any one of claims 1 to 10, wherein the modifying the at least one source powder comprises milling the at least one source powder.

12. The method of any one of claims 1 to 11, wherein the modifying the at least one source powder comprises increasing the surface area of the at least one source powder.

13. The method of claim 11, wherein the milling is selected from the group consisting of dry milling, attrition milling, sonication milling, high energy milling, wet milling, jet milling, and cryogenic milling.

14. The method of claim 11, wherein the milling comprises using a solvent selected from isopropanol or butanol.

15. The method of claim 11, wherein the milling comprises using a solvent selected from methyl-ethyl ketone (MEK) or toluene.

16. The method of claim 11, wherein the milling comprises using a solvent comprises methyl-ethyl ketone (MEK).

17. The method of claim 16, wherein the solvent further comprises isopropanol (IPA).

18. The method of claim 17, wherein the solvent further comprises cyclohexanone.

19. The method of any one of claims 15-18, wherein the ratio of MEK:IPA is 8:2, 7:3, 6:4, 5:5, 4:6, 3:7, or 2:8 w/w.

20. The method of any one of claims 17-18, wherein the amount of cyclohexanone is about 10-25% by weight.

21. The method of any one of claims 15-20, wherein the solvent is an azeotrope.

22. The method of any one of claims 11 to 20, wherein the surface area of the at least one source powder is increased to at least 3 m²/g during the modifying the at least one source powder.

23. The method of claim 22, wherein the surface area of the at least one source powder is increased to at least 5 m²/g during the modifying the at least one source powder.

24. The method of claim 22, wherein the surface area of the at least one source powder is increased to at least 8 m²/g and less than 15 m²/g during the modifying the at least one source powder.

25. The method of any one of claims 1 to 24, wherein the modifying the at least one source powder comprises decreasing an average particle size of particles of the at least one source powder.

26. The method of claim 13, wherein the milling is wet milling or high energy milling.

27. The method of claim 13, wherein the milling comprises using a solvent selected from the group consisting of aprotic solvents, organic solvents, solvents which do not proton exchange Li in a lithium-stuffed garnet, and combinations thereof.

28. The method of claim 13, wherein the milling comprises using a solvent selected from the group consisting of methanol, ethanol, propanol, isopropanol, butanol, isobutanol, t-butanol, pentanol, hexanol, cyclohexanol, cyclohexanone, methyl acetate, ethyl acetate, methyl-ethyl ketone (MEK), acetone, toluene, hexanes, acetic acid, and combinations thereof.

29. The method of any one of claims 1 to 28, wherein the modified source powder has a particle size distribution with a d₅₀ particle size of 100 nm-200 nm, 200 nm-300 nm, 300 nm-400 nm, 400 nm-500 nm, 500 nm-600 nm, 600 nm-700 nm, 700 nm-800 nm, 800 nm-900 nm, 900 nm-1000 nm, 1000 nm-1100 nm, 2000 nm-2200 nm, 3000 nm-3300 nm, or 4000 nm-4400 nm.

30. The method of any one of claims 1 to 28, wherein the modified source powder has a particle size distribution with a d₅₀ particle size of 100 nm-200 nm, 200 nm-300 nm, 300 nm-400 nm, 400 nm-500 nm, 500 nm-600 nm, 600 nm-700 nm, 700 nm-800 nm, 800 nm-900 nm, or 900 nm-1000 nm.

31. The method of claim 30, wherein the d₅₀ is 100 nm-200 nm, 200 nm-300 nm, or 300 nm-400 nm

32. The method of any one of claims 1 to 31, further comprising stress relieving the green tape prior to the sintering.

33. The method of any one of claims 1 to 32, further comprising laminating more than one green tape together.

34. The method of any one of claims 1 to 32, further comprising laminating one green tape on to a second green tape.

35. The method of any one of claims 1 to 32, further comprising, prior to step (d), mixing with the slurry of the modified source powder, a binder selected from the group consisting of polypropylene (PP), atactic polypropylene (aPP), isotactic polypropylene (iPP), polyvinyl butyral (PVB), acrylic, poly ethyl methacrylate (PMMA), poly ethyl methacrylate (PEMA), polyvinyl pyrrolidone (PVP), atactic polypropylene (aPP), isotactive polypropylene ethylene propylene rubber (EPR), ethylene pentene copolymer (EPC), polyisobutylene (PIB), styrene butadiene rubber (SBR), polyolefins, polyethylene-copoly-1-octene (PE-co-PO); PE-co-poly(methylene cyclopentane) (PE-co-PMCP); stereo block polypropylenes, polypropylene polymethylpentene copolymer, poly propylene carbonate, methyl methacrylate, ethyl methacrylate, silicone, and combinations thereof.

36. The method of any one of claims 1 to 35, wherein the slurry comprises a binder selected from the group consisting of polypropylene (PP), atactic polypropylene (aPP), isotactic polypropylene (iPP), polyvinyl butyral (PVB), acrylic, poly ethyl methacrylate (PMMA), poly ethyl methacrylate (PEMA), polyvinyl pyrrolidone (PVP), atactic polypropylene (aPP), isotactive polypropylene ethylene propylene rubber (EPR), ethylene pentene copolymer (EPC), polyisobutylene (PIB), styrene butadiene rubber (SBR), polyolefins, polyethylene-copoly-1-octene (PE-co-PO); PE-co-poly(methylene cyclopentane) (PE-co-PMCP); stereo block polypropylenes, polypropylene polymethylpentene copolymer, poly propylene carbonate, methyl methacrylate, ethyl methacrylate, silicone, and combinations thereof.

37. The method of any one of claims 1 to 36, wherein the at least one source powder is a Li-stuffed garnet compound characterized by the formula LiₓLa_{y}Zr_{z}Oᵣ·qAl₂O₃, wherein 4<x<10, 1<y<4, 1<z<3, 6<t<14, 0≤q≤1.

38. The method of any one of claims 1 to 37, wherein the at least one source powder is a Li-stuffed garnet compound characterized by the formula is Li₇₋ₓLa₃Zr₂O₁₂·qAl₂O₃, wherein q is 0, 0.3, 0.35, 0.5, 0.75, or 1.0 and 0≤x≤1.

39. The method of any one of claims 1 to 38, wherein the modifying the at least one source powder comprises milling the at least one source powder and incorporating a dispersant or polymer selected from group consisting of nitriles, nitrile butadiene rubber, carboxymethyl cellulose (CMC), styrene butadiene rubber (SBR), PVDF-HFP, PAN, aqueous-compatible polymers, atactic polypropylene (aPP), silicone, polyisobutylene (PIB), ethylene propylene rubber (EPR), PMX-200 PDMS (polydimethylsiloxane/polysiloxane, i.e., PDMS or silicone), polyacrylonitrile (PAN), polymethylmethacrylate (PMMA), poly vinylchloride (PVC), poly vinylbutyral (PVB), poly(vinylidene) fluoride-hexafluoropropylene PVDF-HFP, and combinations thereof.

40. The method of any one of claims 1 to 39, wherein providing the slurry comprises formulating the slurry by mixing at least two or more of:
a solvent selected from the group consisting of methanol, MEK, ethanol,
propanol, isopropanol (IPA), acetone, cyclohexanol, toluene, acetic acid, benzene, and a combination thereof;
a binder selected from the group consisting of fish oil, PVB, KD1, an acrylic acid, triton, phosphate esters, derivatives thereof, and combinations thereof;
a plasticizer selected from the group consisting of a benzyl butyl phthalate or di-butyl phthalate;
a pH modifier;
a sintering aid selected; and
a source powder selected from a lithium-stuffed garnet.

41. The method of claim 40, wherein the benzyl butyl phthalate is benzyl butyl phthalate 9S-160™.

42. The method of any one of claims 1 to 41, wherein the modifying comprises classifying the at least one source powder based on a particle size.

43. The method of claim 42, wherein classifying is a technique selected from the group consisting of sieving, centrifugation, and separating particles of different size.

44. The method of claim 42, wherein classifying is a technique selected from the group consisting of sieving, centrifugation, and separating particles of different mass.

45. The method of any one of claims 1 to 42, wherein the slurry has a solid loading of 1% to 99 wt %, wherein the solid loading refers to the amount of source powder.

46. The method of any one of claims 1 to 42, wherein the slurry, when dried, has about 80% w/w source powder.

47. The method of any one of claims 1 to 42, wherein the slurry, when dried, has about 10-25% w/w organic content, wherein the organic content refers to slurry components other than the source powder.

48. The method of any one of claims 1 to 42, wherein the slurry, when dried, has about 10-25% w/w organic content, wherein the organic content refers to slurry components other than the source powder wherein the source powder is a lithium-stuffed garnet.

49. The method of any one of claims 1 to 42, wherein the amount of binder and plasticizer in the slurry is about 10-25% w/w organic content, wherein the organic content refers to slurry components other than the source powder wherein the source powder is a lithium-stuffed garnet.

50. The method of any one of claims 1 to 49, wherein source powder has a particle size distribution having a d₅₀ of 50 nm to 5 μm.

51. The method of any one of claims 1 to 50, wherein the source powder is a lithium-stuffed garnet.

52. The method of any one of claims 1 to 50, wherein the source powder is characterized by the formula Li_{7.1}Zr₂La₃O₁₂+0.5Al₂O₃.

53. The method of any one of claims 1 to 50, wherein the source powder is characterized by the formula Li_{7.1}Zr₂La₃O₁₂+0.5Al₂O₃, as batched.

54. A slurry for preparing a cast green film, the slurry comprising:
at least two or more of:
a solvent selected from the group consisting of methanol, ethanol, propanol, isopropanol, butanol, isobutanol, t-butanol, pentanol, hexanol,
cyclohexanone cyclohexanol, methyl acetate, ethyl acetate, methyl-ethyl ketone (MEK), acetone, toluene, hexanes, acetic acid, and combinations thereof;
a binder selected from the group consisting of fish oil, polyvinylbutylene (PVB), KD1, an acrylic acid, triton, phosphate esters, and derivatives thereof;
a plasticizer selected from the group consisting of a benzyl butyl phthalate or di-butyl phthalate;
optionally a pH modifier;
optionally a sintering aid; and
a source powder selected from a lithium-stuffed garnet

55. The slurry of claim 54, wherein there amount of source powder in is at least 50%, 55%, 60%, 65%, 70%, 75%, 80%, 85%, or 90% by weight.

56. The slurry of claim 54, wherein there amount of source powder is at least 60%, 65%, 70%, or 75 by weight.

57. The slurry of any one of claims 54-56, wherein the source powder is selected from the group consisting of lithium-stuffed garnet, chemical precursors to lithium-stuffed garnet, and lithium stuffed garnet with aluminum oxide dopants.

58. The slurry of any one of claims 54-57, comprising a plasticizer, a pH modifier, and a sintering aid.

59. The slurry of any one of claims 54-58, wherein the source powder comprises garnet powder milled to d₅₀ of about 3 μm, and wherein the binder comprises poly methyl methacrylate in MEK.

60. The slurry of any one of claims 54-59, comprising MEK, a phosphate ester, and cyclohexanone.

61. The slurry of any one of claims 54-60, wherein the solvent selected from methyl-ethyl ketone (MEK) or toluene.

62. The slurry of any one of claims 54-61 wherein the solvent comprises methyl-ethyl ketone (MEK).

63. The slurry of any one of claims 54-62, wherein the solvent further comprises isopropanol (IPA).

64. The slurry of any one of claims 54-63, wherein the solvent further comprises cyclohexanone.

65. The slurry of any one of claims 54-64, wherein the ratio of MEK:IPA is 8:2, 7:3, 6:4, 5:5, 4:6, 3:7, or 2:8 w/w.

66. The slurry of any one of claims 54-65, wherein the amount of cyclohexanone is about 10-25% by weight.

67. The slurry of any one of claims 54-66, wherein the solvent is an azeotrope.

68. The slurry of any one of claims 54-67, wherein the source powder is a lithium-stuffed garnet.

69. The slurry of claim 68, wherein the amount of lithium-stuffed garnet in the slurry is at least 70% w/w.

70. The slurry of any one of claims 54-69, wherein a concentration of the source powder in the slurry is about 50 wt %, and wherein a concentration of the binder in the slurry is about 50 wt %.

71. The slurry of any one of claims 54-70, wherein a concentration of the source powder in the slurry is about 2-80% w/w.

72. The slurry of any one of claims 54-70, wherein a concentration of the source powder in the slurry is about 50 wt %, and wherein a concentration of the binder in the slurry is about 30 wt %.

73. The slurry of claims 54-68, comprising about 47.5 wt % of a solvent and 0.5 wt % of a plasticizer.

74. The slurry of any one of claims 54-73, wherein the green film contains flocs at a density of less than 100/mm² where a floc is a binder aggregate >5 μm in diameter as measured by FIB cross section SEM of a green film.

75. A green tape, comprising:
a source powder;
a solvent;
a binder; and
a dispersant;
wherein the green tape has a picnometry density greater than 3.9 and less than 5.0 g·cm³.

76. The green tape of claim 75, further comprising a member selected from a plasticizer, a pH modifier, and a sintering aid.

77. The green tape of claim 75, wherein the dispersant is selected from KD-1, Fish oil, and Rhodline 4160.

78. The green tape of claim 75, wherein the plasticizer is selected from DBP, BBP, and PEG.

79. The green tape of claim 75, comprising a pH modifier is selected from citric acid or ammonia hydroxide.

80. The green tape of claim 75, comprising a sintering aid is selected from MgO, Al₂O₃, and combinations thereof.

81. The green tape of any one of claims 75-80, wherein solvent is an azeotrope.

82. The green tape of any one of claims 75-81, wherein solvent is a polar aproptic azeotrope.

83. The green tape of any one of claims 75-82, wherein solvent is selected from methyl ethyl ketone (MEK), tetrahydrofuran, toluene, acetone, 1-butanol, 2-butanol, cyclohexane, cyclohexanol, ethanol, isopropanol, methanol, 1-propanol, propylene carbonate, hexane, 1-propanol, m-xylene, and pentane.

84. The green tape of any one of claims 75-83, wherein the solvent is selected from methyl-ethyl ketone (MEK) or toluene.

85. The green tape of any one of claims 75-84, wherein the solvent comprises methyl-ethyl ketone (MEK).

86. The green tape of any one of claims 75-85, wherein the solvent further comprises isopropanol (IPA).

87. The green tape of any one of claims 75-86, wherein the solvent further comprises cyclohexanone.

88. The green tape of any one of claims 75-87, wherein the ratio of MEK:IPA is 8:2, 7:3, 6:4, 5:5, 4:6, 3:7, or 2:8 w/w.

89. The green tape of any one of claims 87-88, wherein the amount of cyclohexanol is about 10-25% by weight.

90. The green tape of any one of claims 75-89, having a polarity index greater than 3.

91. The green tape of claim any one of claims 75-90 comprising a source powder of a lithium-stuffed garnet having a density of 4 g/cm³; and a solvent comprising MEK and IPA.

92. The green tape of claim any one of claims 75-91, comprising a source powder of a lithium-stuffed garnet having a density of 4 g/cm³; and a solvent comprising MEK, IPA, and cyclohexanone.

93. A method of making a green tape, comprising
(a) providing a slurry;
(b) providing a binder mixture;
(c) mixing the slurry with the binder mixture to form a mixed slurry; and
(d) casting the mixed slurry to provide a green tape.

94. The method of claim 93, wherein the slurry comprises at least two or more of:
a solvent selected from the group consisting of methanol, ethanol, propanol, isopropanol, butanol, isobutanol, t-butanol, pentanol, hexanol, cyclohexanol, methyl acetate, ethyl acetate, methyl-ethyl ketone (MEK), acetone, toluene, hexanes, acetic acid, and combinations thereof;
a binder selected from the group consisting of fish oil, polyvinylbutylene (PVB), KD1, an acrylic acid, triton, phosphate esters, and derivatives thereof;
a plasticizer selected from the group consisting of a benzyl butyl phthalate or di-butyl phthalate;
optionally a pH modifier;
optionally a sintering aid; and
a source powder selected from a lithium-stuffed garnet

95. The method of any one of claims 92-93, further comprising sintering the green tape.

96. The method of any one of claims 92-93, comprising milling the slurry prior to step (a).

97. The method of any one of claim 96, wherein the milling the slurry comprises milling until the particle size of the particles in the slurry has a d₅₀ particle size of 100 nm-200 nm, 200 nm-300 nm, 300 nm-400 nm, 400 nm-500 nm, 500 nm-600 nm, 600 nm 700 nm, 700 nm-800 nm, 800 nm-900 nm, 900 nm-1000 nm, 1000 nm-1100 nm, 2000 nm-2200 nm, 3000 nm-3300 nm, or 4000 nm-4400 nm.

98. The method of any one of claims 92-97, wherein the slurry comprises:

| | Weight % |
|---|---|
| Garnet | 65.04% |
| MEK | 7.97% |
| Hexane | 20.49% |
| Rhodline | 6.50%. |
| 4160 | |

99. The method of any one of claims 92-97, wherein the slurry comprises:

| | Weight % |
|---|---|
| Garnet | 65.04% |
| MEK | 7.97% |
| Hexane | 20.49% |
| Rhodline | 6.50%. |
| 4160 | |

100. The method of any one of claims 92-97, wherein the slurry comprises

| | Weight % |
|---|---|
| Garnet | 65.30% |
| 1 butanol | 7.61% |
| Toluene | 20.57% |
| Rhodline 4160 | 6.53% |

101. The method of any one of claims 92-97, wherein the slurry comprises:

| | Weight % |
|---|---|
| Garnet | 65.04% |
| MEK | 7.97% |
| Hexane | 20.49% |
| Rhodline | 6.50%. |
| 4160 | |

102. The method of any one of claims 92-97, wherein the binder mixture comprises

| | Weight % |
|---|---|
| MEK | 15.42% |
| Hexane | 39.65% |
| B72 | 29.47% |
| SANTICIZER | 15.46%. |
| 160 | |

103. The method of any one of claims 92-102, wherein the green tape has a solid loading greater than 50% w/w.

104. The method of any one of claims 92-103, wherein the green tape has a solid loading greater than 60% w/w.

105. The method of any one of claims 92-104, wherein the green tape has a solid loading greater than 70% w/w.

106. The method of any one of claims 92-105, wherein the green tape has a solid loading greater than 80% w/w.

107. The method of any one of claims 92-106, wherein the green tape has a solid loading greater than 90% w/w.

108. The method of any one of claims 92-107, wherein the green tape is a thin film having a film thickness less than 200 μm and greater than 1 nm.

109. The method of any one of claims 92-108, wherein the green tape is a thin film having a film thickness less than 100 μm and greater than 1 nm.

110. The method of any one of claims 92-109, wherein the green tape is a thin film having a film thickness less than 75 μm and greater than 1 nm.

111. The method of any one of claims 92-110, wherein the green tape is a thin film having a film thickness less than 50 μm and greater than 1 nm.

112. The method of any one of claims 92-111, wherein the green tape is a thin film having a film thickness less than 25 μm and greater than 1 nm.

113. The method of any one of claims 92-112, wherein the green tape is a thin film having a film thickness less than 10 μm and greater than 1 nm.

114. The method of any one of claims 92-113, further comprising (e) drying the green tape.

115. The method of any one of claims 92-113, further comprising (e) drying the green tape until it has an organic content amount of about 10-25% w/w, wherein the organic content is the content other than the source powder.

116. The method of any one of claims 92-113, further comprising (f) laminating a second green tape to the green tape made in claim 92 to make a stack of green tapes.

117. The method of any one of claims 92-115, further comprising sintering the green tape.

118. The method of any one of claims 92-116, further comprising sintering the stack of green tape.
